(19) United States
(12) Patent Application Publication
(10) Pub. No.: US 2026/0338939 A1
(43) Pub. Date: Oct. 29, 2026

(54) Range and Velocity Estimation of a Target Beyond Nyquist Limit

(71) Applicant: Mitsubishi Electric Research Laboratories, Inc., Cambridge, MA (US)

(72) Inventors: Joshua Rapp, Somerville, MA (US); Alfred Ulvog, Brighton, MA (US); Vivek K. Goyal, Cambridge, MA (US)

(73) Assignee: Mitsubishi Electric Research Laboratories, Inc., Cambridge, MA (US)

(21) Appl. No.: 19/208,978

(22) Filed: May 15, 2025

Related U.S. Application Data
(60) Provisional application No. 63/795,570, filed on Apr. 27, 2025.

(51) Int. Cl. G01S 13/58; G01S 7/35; G01S 13/34

(52) U.S. Cl. CPC G01S 13/584; G01S 7/356; G01S 13/345

(57) ABSTRACT

A frequency estimation method utilizing an FMCW device comprises transmitting a wave of radiation to a scene, receiving a reflection of the transmitted wave from the scene, and interfering a copy of the transmitted wave with the received reflection to generate a sequence of samples of the interference signal. The method also comprises generating an estimate of instantaneous frequency of the interference signal based on the samples of the interference signal and estimating time delay and Doppler shift between the transmitted wave and the received reflection by maximizing a negative log likelihood function of the instantaneous frequency. A target's range and velocity is determined from the estimated time delay and Doppler shift.

### TECHNICAL FIELD

The present disclosure relates generally to object detection in a scene using frequency modulated continuous wave (FMCW) techniques, and more particularly, to FMCW based systems and methods for estimating unambiguous range of the object beyond the limit set by the Nyquist rate.

### BACKGROUND

Several application areas such as autonomous vehicles, industrial robotics, navigation, aerospace, meteorological element measurement, atmospheric environment monitoring etc. require precise detection of objects for performing critical functions. Reliable object detection is usually performed using remote sensing techniques such as Light Detection and Ranging (LiDAR) that uses light in the form of a pulsed laser to measure ranges (variable distances) to objects in a scene. One such technique used for range estimation is frequency-modulated continuous-wave (FMCW) lidar which utilizes a constant illumination power making it compatible with integrated photonics. FMCW lidar is a coherent ranging technology that measures distance by mixing a local copy of the transmitted beam with the light reflected back to the receiver. The beat frequency of the resulting interference signal is proportional to the reflector range, so distance measurement becomes a frequency estimation problem.

The existing FMCW implementations emphasize simple signal processing such as range estimation via the fast Fourier transform (FFT) algorithm and peak-finding. However, this results in hardware-focused solutions requiring linear swept-frequency laser sources or linearized resampling. Also, the maximum range achievable by the existing FMCW systems is arbitrarily limited in order to use receivers with lower sampling rates without aliasing. This renders the existing FMCW approaches unsuitable for estimating ranges beyond the limit set by the Nyquist criteria. Also, with these existing FMCW-based systems, due to the delay between the transmitted and received signals causing an overlap region in the interference measurement, there exists a tradeoff between the precision of the range estimation, between the sampling rate and the maximum range. Furthermore, such systems require the laser frequency to be swept linearly with time which is difficult to attain using linear modulation of the laser drive current/voltage. The sampling rates for these existing systems are in the ranges of megahertz and gigahertz, which mandates the use of complicated and costly ADCs.

Accordingly, better approaches for estimating range and velocity of targets without being limited by bandwidth and sampling rate are needed.

### SUMMARY

It is an object of some embodiments to provide range and velocity estimation approaches that encompass simple hardware solutions supported by robust signal processing for determining the range and velocity of movable targets. Various example embodiments provide improved frequency estimation techniques for determining range of objects in a scene of interest. Accordingly, some example embodiments are specifically directed towards providing range and velocity estimation techniques for scenarios where the maximum distance to be measured is greater than the limit defined by the Nyquist rate.

Some example embodiments are based on the realization that for coherent ranging techniques such as FMCW, the object distance measurement task becomes a frequency estimation problem since the distance to an object in a scene is a function of the beat frequency of the interference signal resulting from a mixing of a local copy of the transmitted beam with the light reflected back to the receiver. In such coherent ranging techniques, depth measurement is affected by correlated noise. Accordingly, some example embodiments are based on a realization that for FMCW lidar, the phase noise from the source laser as well as the shot noise from the photodetector causes the interference signal to deviate from the true beat frequency and as such the beat frequency estimation is prone to error.

Some embodiments also realize that the delay t between transmission and reception of signals causes an overlap region in the interference measurement that is typically not a constant beat frequency (CBF). Since the length of the overlap (τ) is unknown in advance, a fixed measurement time Tₘₑₐₛ is specified that ensures a CBF. Given a chirp period T_{chirp}, the measurement time then places an upper bound on the delay (and thus the range) that can be measured: Tₘₐₓ=T_{chirp}−Tₘₑₐₛ, where 0<Tₘₑₐₛ<T_{chirp}. Since the precision of the estimate is inversely proportional to the length of Tₘₑₐₛ, there is a tradeoff between precision and maximum range. Furthermore, the Nyquist rate of the receiver depends on τₘₐₓ because longer range corresponds to higher frequency. Thus, there is a tradeoff between the sampling rate and the maximum range.

Some embodiments are also based on another realization that a downside of the CBF approach is that it requires the laser frequency to be swept linearly with time. However, linear modulation of the laser drive current or voltage typically results in a nonlinear sweep. Also, the sampling rates are still in the MHz to GHz range, requiring complex and expensive ADCs. For example, a limitation of swept-source lasers is the purity of the frequency as a function of time, measured by the linewidth and affects the maximum range for which the transmitted and received signals can be considered correlated. Although there have been some attempts to produce lower-linewidth lasers to extend the useful range that can be measured, some embodiments realize that carefully modeling the noise in swept-source lasers leads to estimation algorithms that, although more sophisticated than peak detection, can yield improved estimation of distant targets far beyond the laser coherence range.

Accordingly, some embodiments provide an improved framework for processing FMCW signals that solve for larger range of distance and velocity by modelling the entire duration of the signal. It is a realization of some embodiments that interference measurements contain range and velocity information, even if the beat signal has no constant frequency component. As such, a robust modelling and signal processing enables extraction of range and velocity despite having aliased measurements and/or no beat frequency component at all. Accordingly, some embodiments define range and velocity estimation as a parameter estimation problem. In this regard, some embodiments involve regressing over the frequency trajectory or instantaneous frequency (IF) of the interfered signal. The IF estimation may be achieved by taking first difference of the phase. Some embodiments formulate a likelihood function of range and velocity from the knowledge of the phase noise and shot noise present in the signal, and the approximate likelihood of the extracted IF is maximized to estimate the distance and velocity.

Various embodiments provide systems and methods for performing range and velocity estimation by observing the interference signal in its entirety rather than only at the constant beat frequencies. Towards this end, some embodiments extend the observation limit for range estimation beyond the standard constant beat frequency (CBF) in the interfered signal. By considering the entire measurement sequence, certain frequency modulations enable unambiguous recovery of range beyond the limit set by the Nyquist rate, despite the ambiguity introduced by aliasing.

Particularly, it is a realization of some embodiments that estimation based on only observing the CBF cannot resolve the parameters when the CBF goes beyond the Nyquist rate. Using CBFs alone limits the pairs of time delay and Doppler shift (τ, f) of received signal that are recoverable even when the full received signal would enable recovery. One solution in this regard is to reduce the bandwidth of the chirp signal generated for the emitter so that the CBF is within the Nyquist rate for a longer range. However, some embodiments realized that doing so leads to lower resolution in the resulting periodogram and therefore lower accuracy in the estimate of the frequency.

To overcome this, various example embodiments described herein resolve a larger (τ, f) space without changing the transmission scheme. In this regard, some embodiments use the full received signal instead of only certain portions of the received signal corresponding to the CBFs. Some embodiments estimate the instantaneous frequency of the interfered signal independent of the global constant phase offset. A solver solves for the delay τ and Doppler shift f by minimizing the distance between the instantaneous frequency estimate ζ[n] and noiseless instantaneous frequency in discrete time g_{τ,f}[n]. In this regard, it is another realization of some embodiments that minimizing the geodesic distance between the instantaneous frequency estimate ζ[n] and noiseless instantaneous frequency in discrete time g_{τ,f}[n] is equivalent to minimizing the negative log-likelihood of the wrapped normal distribution with σ²→0.

In this way, various embodiments described herein provide a robust alternative to the conventional approaches for range estimation of targets. Since the proposed approaches do not condition the range estimation task on the beat frequencies, the estimated range has better precision than what is obtained from conventional counterparts. The proposed approaches for range estimation solve a larger range of distance and velocity pairs as compared to the conventional counterparts because the distance that can be solved for by the proposed approaches is limited by neither the bandwidth nor the sampling rate. The systems and methods described in several embodiments of the disclosure can perform the range and velocity estimation even when frequency aliasing occurs across time and is flexible for arbitrary frequency modulations of the transmitted signal.

Moreover, various embodiments dynamically handle noise modelling and compensate for various noise sources that would otherwise distort the measurements. This allows for accurate parameter estimation, even under less-than-ideal conditions where conventional range estimation methods fail.

In particular, various embodiments adapt to variations in system noise, allowing for robust operation across a wide range of measurement scenarios. The proposed solution does not require the additional hardware complexity or high sampling rates that conventional systems demand, making it more cost-effective and simpler to implement. The novel and inventive range estimation approach described herein provides accurate, real-time range and velocity estimation, even in the presence of aliased measurements or non-linear frequency modulations, offering a significant advantage over conventional FMCW lidar approaches.

Additionally, various embodiments offer flexibility in handling various sources of error, enabling their application in a wide variety of operational environments. This provides a reliable and efficient alternative to traditional lidar systems that rely heavily on constant beat frequencies and spectral-domain processing.

In order to achieve the aforementioned objectives and advantages, some example embodiments provide systems, methods, and programs for FMCW-based range estimation of an object in the scene.

For example, some example embodiments provide an FMCW device comprising an emitter, a receiver, a mixer, an analog to digital converter (ADC), and a processing circuitry. The emitter is configured to transmit at least one wave of radiation to a scene, wherein the transmitted wave is modulated in the optical frequency domain. The receiver receives a reflection of the transmitted wave from the scene, and the mixer interferes a copy of the transmitted wave with the received reflection of the transmitted wave to generate an interference signal. The ADC generates digitized samples of the interference signal that are then processed by the processing circuitry to estimate the range and velocity of a target in the scene. In this regard, the processing circuitry generates an estimate of the instantaneous frequency of the interference signal, based on the samples of the interference signal. The time delay and Doppler shift between the transmitted wave and the received reflection are estimated by maximizing a negative log likelihood function of the instantaneous frequency. The processing circuitry determines the range and velocity of the target in the scene based on the estimated time delay and Doppler shift between the transmitted wave and the received reflection.

Some example embodiments also provide a frequency estimation method utilizing an FMCW device. The method comprises transmitting a wave of radiation to a scene, receiving a reflection of the transmitted wave from the scene, and interfering a copy of the transmitted wave with the received reflection to generate a sequence of samples of the interference signal. The method also comprises generating an estimate of instantaneous frequency of the interference signal based on the samples of the interference signal and estimating time delay and Doppler shift between the transmitted wave and the received reflection by maximizing a negative log likelihood function of the instantaneous frequency. A target's range and velocity is determined from the estimated time delay and Doppler shift.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a workflow for range and velocity estimation in a scene using principles of a frequency modulation continuous wave (FMCW) device, according to some example embodiments;

FIG. 1B shows the schematic of an FMCW lidar system for producing an estimate of the distance and velocity to an object, according to some example embodiments;

FIG. 2A illustrates a detailed schematic of an FMCW lidar system, according to some embodiments;

FIG. 2B illustrates an exemplar method for distance and velocity estimation using an FMCW lidar system, according to some example embodiments;

FIG. 3A illustrates transmitted and received signals in an FMCW system with triangular modulation for moving targets at two distances with the same velocity;

FIG. 3B illustrates sampled interference signals for real and complex measurement systems, with instantaneous frequency IF overlaid on short-time Fourier transform (STFT) plots;

FIG. 4A illustrates the constant beat frequency (CBF) space and unambiguous space for a real signal;

FIG. 4B illustrates the CBF space and unambiguous space for a complex signal;

FIG. 4C illustrates the CBF space and unambiguous space for a modified complex signal where an alternate mapping is utilized;

FIG. 5 illustrates unambiguous range of time delay and Doppler shift space of an FMCW system according to some example embodiments;

FIG. 6 illustrates a maximum likelihood estimator based range and velocity estimation method utilizing principles of a FMCW lidar system, according to some example embodiments;

FIG. 7 illustrates a scenario depicting an example use case of an FMCW lidar system, according to some example embodiments; and

FIG. 8 illustrates a block diagram of a system for implementing an FMCW lidar system, according to some example embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

There has been a widescale adoption of imaging techniques in several application areas owing to the need to understand the environment around a subject for taking informed decisions. For example, in remote sensing applications, it is often desired that the physical characteristics of an area be described in as much clarity as possible. In other applications such as autonomous and semi-autonomous vehicles, taking time bound decisions is critical for the operation of such vehicles. For all such applications it is essential that depth estimation of objects in the scene of interest be performed accurately. Precise depth estimation is achievable by taking into consideration errors that occur in taking measurements of the scene. In most such scenarios the illumination source often introduces such errors in the measurements.

Lidar is an increasingly popular sensing modality for ranging applications varying from autonomous driving to industrial robotics and lunar navigation. Conventional pulsed lidar transmits a short pulse of light toward an object, and the distance to the object is calculated from the time that elapses until the reflected light returns to the lidar system. Since pulsed lidar is incoherent, measuring only the intensity of light at the detector, it is susceptible to errors due to ambient light or interference from other lidars. An alternative approach to distance estimation via laser light is frequency-modulated continuous-wave (FMCW) lidar. Unlike pulsed lidar, FMCW lidar has constant illumination power, which makes it compatible with integrated photonics. FMCW lidar is a coherent ranging technology that measures distance by mixing a local copy of the transmitted laser beam with the light reflected back to the receiver. The beat frequency of the resulting interference signal is proportional to the reflector range, so distance measurement becomes a frequency estimation problem.

Existing FMCW implementations emphasize simple signal processing e.g., range estimation via the fast Fourier transform (FFT) algorithm plus peak-finding which results in hardware-focused solutions requiring linear swept-frequency laser sources or linearized resampling. With such systems, the maximum achievable range is arbitrarily limited in order to use receivers with lower sampling rates without aliasing.

Conventionally in FMCW ranging, a linear chirp signal is generated and mixed/interfered with the received signal, which is the time-delayed/Doppler-shifted counterpart of the transmitted signal. Mixing the two signals generates a constant beat frequency (CBF) in parts of the interfered signal. This is convenient since CBFs can be easily converted to delay and Doppler shift (distance and velocity), and CBF can be estimated by simply finding the frequency bin with maximum in the periodogram. However, signals are often perturbed by noise. In particular case of FMCW lidar, shot-noise from the photodetector and phase noise from the source laser can deviate the estimate of CBF. Frequency estimators that only assumes presence of additive noise are not the best estimators as method such as Lorentzian fitting that considers correlated phase noise often leads to more accurate estimates of the CBFs. However, CBFs are not the only thing being produced by the interfered signal. The flaw in the conventional range/velocity estimation is that it completely ignores the non-CBF part.

Various example embodiments described herein provide a different paradigm to FMCW based range estimation. In this regard, some embodiments provide a framework for processing FMCW signal that resolves for a larger range of distance and velocity by modelling the entire duration of the signal. The framework involves regressing over the frequency trajectory or instantaneous frequency (IF) of the interfered signal. A likelihood function of the range and velocity is formulated from the knowledge of phase noise and shot noise present in the signal. The approximate likelihood of the extracted IF is maximized to estimate the distance and velocity. Such a framework solves for a larger range of pair of distance and velocity compared to the conventional approaches. The distance that can be solved for is limited by neither the bandwidth nor the sampling rate. The framework also allows the IF to be aliased across time and is flexible for arbitrary frequency modulation for distance/velocity estimation.

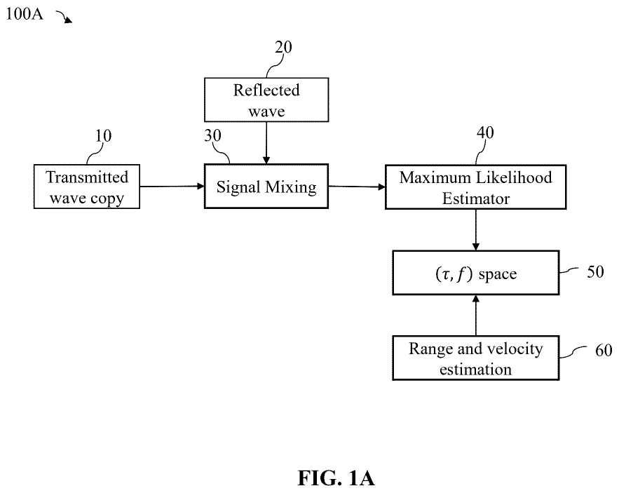

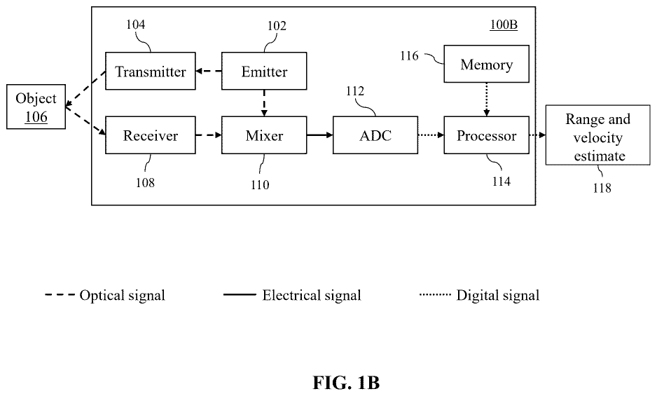

A Frequency Modulated Continuous Wave lidar or FMCW lidar system is a special type of lidar system that measures both distance and velocity of moving objects. This is achieved by continuously varying the frequency of the transmitted signal by a modulating signal at a known rate over a fixed time period. This modulation is often used for a very precise distance measurement at close range by phase comparison of the two echo signal frequencies. FIG. 1A illustrates a workflow 100A for range and velocity estimation in a scene using principles of a frequency modulation continuous wave (FMCW) device, according to some example embodiments.

A transmission wave for transmission into a scene is generated by one or more lasers of a lidar and fired towards the scene through suitable transmitters of the FMCW lidar system. A copy 10 of the transmitted wave is also stored locally for further processing. The transmitted wave is reflected from the scene and a reflected wave 20 is collected by suitable receivers of the FMCW lidar system.

The transmitted signal is a frequency modulated wave:

$${x}_{TX} ( t ) = \sqrt{2 {P}_{TX}} cos ( 2 π {\int }_{0}^{t} a ( s ) ds + b + ω ( t ) ) \qquad ( 1 )$$

where P_{TX} is the power of the signal, a(t) is a continuous function that is determined by the system design, ω(t) is the phase noise from the laser, b is an arbitrary constant phase offset. In some embodiments, the continuous function a(t) may be a triangular function. The received signal x_{RX}(t) is time delayed by τ and Doppler shifted by f.

The copy 10 of the transmitted wave and the reflected wave 20 are fed into a mixer for signal mixing 30 which outputs measurements pertaining to the resultant interference signal. As a part of the mixing process, the optical signals may be converted into analog electronic signals which are then digitized to produce samples of the interference signal.

In some embodiments, the in-phase interference measurements and quadrature measurements of the resultant interference signal may be obtained as output of the signal mixing process 30. In some example embodiments, FMCW receivers may use a single balanced detector to capture the in-phase interference measurements, and the quadrature measurements are computed from the in-phase interference measurements via a Hilbert transform. In some example embodiments, a quadrature demodulator with two pairs of balanced detectors may capture both the in-phase measurements and the quadrature measurements.

The signal processing aspects of the workflow 100A include executing a maximum likelihood estimator 40 for the instantaneous frequency of the interference signal to determine the time delay τ and Doppler shift f in the interference signal corresponding to each instance of the instantaneous frequency. This yields the (τ, f) space 50 from which the range or distance and the velocity of the target are estimated 60. The time delay and Doppler shift are directly related to the distance d and velocity v of a target as:

$$d = \frac{τ c}{2} , v = \frac{f {λ}_{c}}{2} ,$$

where c is the speed of light and λ_{c} is the wavelength of the light.

The exemplar workflow 100A may be compiled as a machine executable process or method and may be executed with an FMCW device or a lidar system. Details of the components and working of such an FMCW lidar system are described next with reference to FIG. 1B which illustrates a schematic of an FMCW lidar system 100B that produces an estimate 118 of the range and velocity of an object 106. The FMCW lidar system 100B comprises an emitter 102, a transmitter 104, a receiver 108, a mixer 110, an analog-to-digital converter (ADC) 112, a processor 114, and a memory 116.

In some example embodiments, the emitter 102 comprises a suitable light source such as laser and frequency modulation electronics. In some embodiments, the laser may be a tunable laser, and the frequency is modulated by controlling the laser oscillation directly. In some example embodiments, the laser may be a fixed-frequency laser, and the frequency may be modulated externally, e.g., using an electro-optical modulator. In some example embodiments, the emitter 102 transmits to a scene, a wave of radiation (such as the laser). Prior to transmission, the wave of radiation may be modulated in the frequency domain. For example, the wave may be modulated using a modulation function that is subject to one or more impairments. The impairments may arise due to for example source phase noise causing non-linearity of the wave of radiation in the frequency domain.

In some example embodiments, the transmitter 104 comprises optics that steer and focus the laser beam on the object 106 to be measured/tracked. Focus may be achieved via a lens or combination of lenses. Beam-steering technologies utilized by some example embodiments include without limitation, mechanically-scanned mirrors, optical phased arrays, microelectromechanical systems (MEMS) mirrors, and liquid crystal meta surfaces.

The receiver 108 comprises focusing optics to collect light reflected from the object. The receiver may comprise a lens or lenses to focus the reflected light and a free-space-to-fiber coupler to couple the received light into a fiber optic cable.

The mixer 110 optically combines a copy of the light from the emitter 102 (the local oscillator) with light captured by the receiver to generate an interference signal. In some embodiments, the mixing is performed with a beam-splitter. In other embodiments, mixing is performed by a fiber-optic coupler. A detector of the mixer 110 then converts the optical signal to an analog electronic signal (e.g., a voltage or a current). The detector may be a single photodiode or a combination of photodiodes, such as in a balanced detector. The detector may also include amplification circuitry to increase the level of the electrical signal.

The ADC 112 converts the analog electrical signal to a digital signal at predetermined sampled times. The ADC 112 comprises sampling and quantization electronics that output a digital signal. In some embodiments, the ADC 112 has uniformly-spaced samples in time. In other embodiments, the ADC 112 uses an external reference such as a k-clock to determine sample times to correspond with a linear frequency sweep of the laser.

The processor 114 uses the digitized samples of the interference signal to estimate the distance to the object. In some embodiments, the processor 114 is an on-board device such as a field-programmable gate array (FPGA). In other embodiments, the processor 114 is an external computer. The memory 116 amongst other things contains calibration data and parameters needed for the processor to make an accurate range and velocity estimate 118.

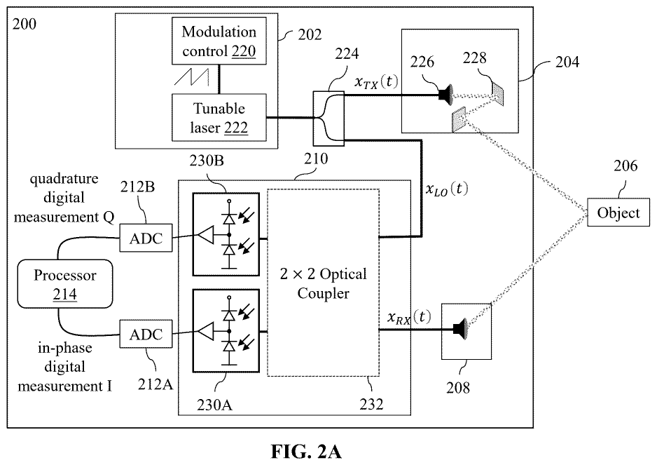

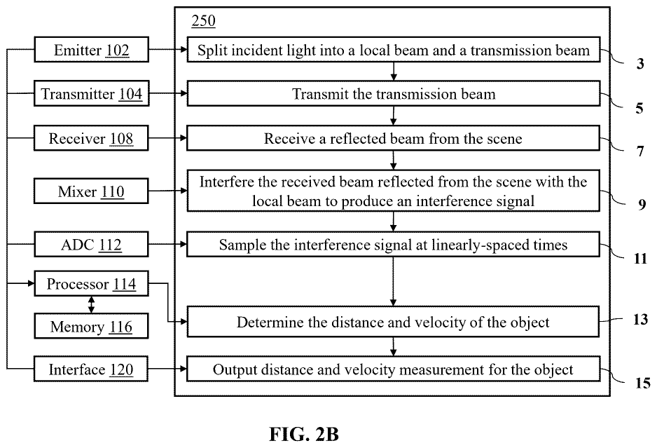

FIG. 2A illustrates a detailed schematic of an FMCW lidar system 200, according to some embodiments. In some example embodiments, the FMCW lidar system 200 may be embodied as a device. In some example embodiments the FMCW lidar system 200 may be a distributed system comprising electrical devices and optical devices. For example, the FMCW lidar system 200 may be realized using a controller and an opto-electronic device. The controller may comprise the data processing components of the FMCW lidar system 200 such as the processor and its associated circuitry. The opto-electronic components may comprise other electrical and optical components of the FMCW lidar system 200. The FMCW lidar system 200 comprises an emitter 202, a transmitter 204, a receiver 208, a mixer 210, a pair of analog-to-digital converters (ADC) 212A and 212B, and a processor 214.

The emitter 202 comprises a tunable laser 222 and its modulation controller 220. The tunable laser 222 is fiber-coupled and connected to a splitter 224 that creates two copies of the laser beam. The first copy is sent to the transmitter 204, in which a collimator 226 focuses the light from the optical fiber into a bundle of parallel rays. Beam-steering optics, such as a pair of galvo mirrors 228, are used to direct the transmit beam towards the object 206.

In some embodiments, the wavelength of the tunable laser 222 may be swept by a modulation controller 220 so that the optical frequency of the laser beam is a function of time. In some embodiments, the modulation may be linear or a linear function affected by some nonlinear response, or a desired nonlinear function, such as a sinusoid. Some embodiments also take into account random deviations from the desired modulation, i.e., phase noise. Thus, the wave of radiation produced by the emitter 202 may be modulated in the frequency domain using a known modulation function that is subject to random impairments such as phase noise. The wave of radiation is emitted as a frequency signal from the tunable laser 222 and its delayed copy is captured at the receiver 208 of the FMCW lidar system 200, according to some example embodiments.

Light reflected from the object 206 is captured at the receiver 208, which focuses light from free space into an optical fiber. The second copy of the laser beam is sent to the mixer 210 to interfere the reflected delayed copy of the laser beam with the second copy of the laser beam. In this regard, the local oscillator x_{LO}(t), which is a copy signal of x_{TX}(t), and the received signal x_{RX}(t) are transformed through a 2×2 optical coupler 232 to produce x₊(t) and x₋(t) as

$$[ \begin{matrix}{x}_{+} ( t ) \\ {x}_{-} ( t )\end{matrix} ] = [ \begin{matrix}1 / \sqrt{2} & 1 / \sqrt{2} \\ 1 / \sqrt{2} & - 1 / \sqrt{2}\end{matrix} ] [ \begin{matrix}{x}_{LO} ( t ) \\ {x}_{RX} ( t )\end{matrix} ] \qquad ( 2 )$$

x₊(t) and x₋(t) are measured using photodetectors 230A and 230B, respectively, which measure the intensities of the field while suppressing high frequency terms. The output of the corresponding photodetectors is:

$${y}_{+} ( t ) = {\vert {x}_{+} ( t ) \vert}^{2} \approx \frac{B}{2} + \frac{A}{2} cos ( ϕ ( t ) + ξ ( t ) ) + {η}_{+} ( t ) \qquad ( 3 a )$$

$${y}_{-} ( t ) = {\vert {x}_{-} ( t ) \vert}^{2} \approx \frac{B}{2} - \frac{A}{2} cos ( ϕ ( t ) + ξ ( t ) ) + {η}_{-} ( t ) \qquad ( 3 b )$$

where

B=R_{PD}(P_{LO}+P_{RX}),A=2R_{PD}\sqrt{P_{LO}P_{RX}} (4)

$$ϕ ( t ) = 2 π {\int }_{t - τ}^{t} a ( s ) ds + 2 π ft \qquad ( 5 )$$

$$\begin{matrix}ξ ( t ) = ω ( t ) - ω ( t - τ ) & ( 6 )\end{matrix}$$

η₊(t) and η₋(t) are shot noise from each photodetector and R_{PD} is the photodetector's responsivity. The DC and AC components are separated by summation and subtraction operations. Each of the ADCs (212A or 212B) comprises circuits that low-pass-filter, sample, and quantize the electrical signal to produce the in-phase (I) and quadrature (Q) digital measurements. The in-phase components may be expressed as:

u^{I}(t)=y₊(t)−y₋(t) (7)

which yields,

u^{I}(t)=2R_{PD}\sqrt{P_{LO}P_{RX}} cos(φ(t)+ξ(t))+ηᵤ^{I}(t) (8)

The variance of added and subtracted shot-noise are

$$var \{ {η}_{u}^{I} ( t ) \} = var \{ {η}_{v}^{I} ( t ) \} = {qR}_{PD} ( {P}_{TX} + {P}_{RX} ) \qquad ( 9 )$$

where q is the charge of electron.

In some embodiments, to produce the quadrature component, optical Hilbert transform may be applied on x_{LO}(t) to produce

$${x}_{LO}^{Q} ( t )$$

and is replaced with x_{LO}(t) to the 2×2 coupler input. Following the same procedure the quadrature components are obtained as:

$${u}^{Q} ( t ) = 2 {R}_{PD} \sqrt{{P}_{LO} {P}_{RX}} sin ( ϕ ( t ) + ξ ( t ) ) + {η}_{u}^{Q} ( t ) \qquad ( 10 )$$

Some example embodiments model the observed interference signal as a complex valued sinusoid of the in-phase measurements and the quadrature measurements as:

u(t)=u^{I}(t)+ju^{Q}(t)=Ae^{j(φ(t)+ξ(t))}+ηᵤ(t) (11)
where A is the signal amplitude and ηᵤ(t) corresponds to a stationary random process denoting the phase change.

With bandwidth B and chirp rate T, triangular modulation produces the following instantaneous frequency:

$$\frac{1}{2 π} \frac{d ϕ}{dt} = \{ \begin{matrix}2 \frac{B}{T} ( t - \frac{1}{2} τ ) + f , & t ∈ [ 0 , τ ] \\ \frac{B}{T} τ + f , & t ∈ [ τ , T ] \\ - 2 \frac{B}{T} ( t - T - \frac{1}{2} τ ) + f , & t ∈ [ T , T + τ ] \\ - \frac{B}{T} τ + f , & t ∈ [ T + τ , 2 T ]\end{matrix} \qquad ( 12 )$$

The second and fourth segments are referred to as constant beat frequency (CBF) segments as:

$${f}_{b}^{( 1 )} = ( B / T ) τ + f and {f}_{b}^{( 2 )} = - ( B / T ) τ + f \qquad ( 13 )$$

$${f}_{b}^{( 1 )} and {f}_{b}^{( 2 )}$$

can easily be converted to distance and velocity estimates via scaled sums and differences:

$$τ = \frac{1}{2} \frac{T}{B} ( {f}_{b}^{( 1 )} - {f}_{b}^{( 2 )} ) and f = \frac{1}{2} ( {f}_{b}^{( 1 )} + {f}_{b}^{( 2 )} ) \qquad ( 14 )$$

However, simple peak detection is not the most effective depth estimation strategy since spectral widening occurs due to phase noise and modelling the phase noise can yield improved estimation far beyond the laser coherence range. Under a white frequency noise assumption, the power spectral density of the phase noise can be approximated by a Lorentzian function parameterized by the laser linewidth and a strategy such as nonlinear least squares fitting of a Lorentzian function on the periodogram outperforms frequency estimators that only address additive noise.

Some embodiments consider both laser phase noise and photodetector shot noise. Usual assumption for the laser phase noise is that the laser has a frequency noise that is a white Gaussian process. This modeling leads to ω(t) being a Wiener process with its variance scaled by the laser linewidth L. As a result, ξ_{τ}(t) is a zero-mean stationary Gaussian process that has a triangular autocorrelation function

R_{ξ}(u)=max{2πL(τ−|u|),0} (15)

The signal to noise ratio with respect to only shot noise is given as:

$$S N {R}_{n} = \frac{2 {R}_{PD}^{2} {P}_{LO} {P}_{RX}}{{qR}_{PD} ( {P}_{LO} + {P}_{RX} )} \qquad ( 16 )$$

Referring to FIG. 2A, the processor 214 operates on the in-phase and quadrature components together as complex interference signals to ascertain the unambiguous delay t and Doppler shift f space (hereinafter also referred to as (τ, f) space) for the target/object 206. Some embodiments resolve for a larger (τ, f) space without changing the transmission scheme through the use of the full received signal rather than only CBFs.

In some example embodiments, the FMCW lidar system 200 may be a FMCW device. In some alternate embodiments, the lidar system may be external to the FMCW device, wherein the FMCW device may control one or more operations of the lidar. Irrespective of its realization, the FMCW lidar system 200 may execute the workflow 100A as a process or method.

FIG. 2B illustrates one such exemplar method 250 for distance and velocity estimation using an FMCW lidar system such as the FMCW lidar system 200, according to some example embodiments. The method 250 comprises splitting 3 the incident light into a local beam and a transmission beam. The splitting 3 may be performed by the emitter 202 of the FMCW lidar system 200. The transmission beam is transmitted 5 towards a scene of interest by the transmitter 204 of the FMCW lidar system 200. A reflection of the transmission beam from the scene is received 7 by the receiver 208 of the FMCW lidar system as a reflected beam. One or more objects may reflect the transmission beam in the scene towards the FMCW lidar system. The mixer 210 interferes 9 the received beam reflected from the scene with the local beam to produce an interference signal. In this regard, the mixer 210 may perform the interference according to principles of the signal mixing 30 process of the workflow 100A.

One or more analog to digital converters (ADC) 112 sample 11 the interference pattern at linearly spaced frequencies to generate samples of the interference signals in the manner described with reference to the workflow 100A of FIG. 1A. One or more processors 114 may interface with a memory 116 storing executable programs, data, and instructions to determine 13 a distance and velocity to a target object in the scene through maximum likelihood estimation of the instantaneous frequency of the interference signal details of which are explained later in the disclosure. The one or more processors 114 may control an interface 120 such as an output device to output 15 the determined distance and velocity of the target object in any suitable manner.

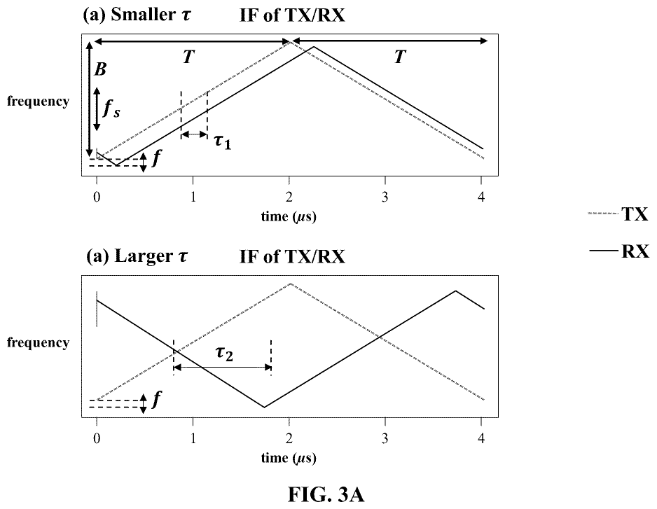

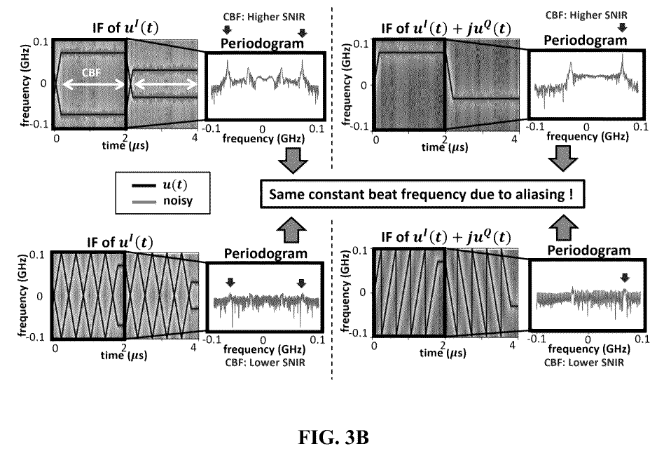

FIG. 3A illustrates transmitted signals (shown with dashed line) and received signals (shown with continuous line) in a system with triangular modulation for moving targets at two distances with same velocity. Referring to FIG. 3A, the top row corresponds to the shorter distance while the bottom row corresponds to the longer distance. τ corresponds to the time delay between the received signal (RX) and its corresponding transmitted signal (TX) while f corresponds to the Doppler shift between them. Particularly, FIG. 3A shows instantaneous frequencies (IFs) of simulated signals. Since the targets are moving, each received signal (RX) has both a delay t (shift to the right) and a Doppler shift f (vertical shift) relative to the corresponding dashed TX curve.

FIG. 3B illustrates sampled interference signals for real (left column) and complex (right column) measurement systems, with instantaneous frequency IF overlaid on short-time Fourier transform (STFT) plots. The top row corresponds to the shorter distance while the bottom row corresponds to the longer distance. Particularly, FIG. 3B depicts the use of real (in-phase only) and complex (in-phase and quadrature) interference signals, sampled at rate fₛ. Superimposed on the short-time Fourier transform (STFT) magnitude plots are idealized IFs. The zig-zags in the IFs of the depicted interference signals are caused by aliasing. To the right of each STFT plot is the periodogram of the interference signal on (0, T).

It may be noted that the sampling rate is sub-Nyquist in the larger distance scenario. Referring to FIG. 3B, in conventional FMCW systems, a periodogram is used to estimate the constant beat frequency (CBF). However, CBF alone is not enough to distinguish the delay t beyond aliasing, which leads to a limit on unambiguous range based on the sampling rate of the detector. Furthermore, with longer distance, the CBF signal-to-noise and interference ratio decreases.

Some embodiments realize that primarily three major limitations exist with the conventional FMCW systems. These are discussed below:

Sample inefficiency: Consider the complex case (right panel) in top row of FIG. 3C and the extraction of constant beat frequency

$${f}_{b}^{( 1 )} .$$

Conventionally the beat frequency is estimated by periodogram from either duration (0, T) or (τₘₐₓ, T) for a prespecified allowed maximum delay τₘₐₓ. The problem with first method is that it includes non-constant frequencies, and the second method disregards samples. Either way, the valuable information is lost either due to model mismatching or ignoring some of the signals.

Limited unambiguous (delay, Doppler) space: As illustrated by the coincidence of CBFs in FIG. 3B, the maximum unambiguously recoverable delay is constrained by the sampling rate and the modulation bandwidth. When triangular modulation is used (Equation 12), aliasing occurs when

$$( \frac{B}{T} ) τ + f exeeds \frac{{f}_{s}}{2} ;$$

thus, with zero Doppler, aliasing occurs for τ above

$$\frac{{Tf}_{s}}{2 B} .$$

This limits the maximum unambiguous delay τ to min

$$\{ \frac{2 {Tf}_{s}}{B} , 2 T \} .$$

It may be noted that when T and fₛ are held constant, increasing modulation bandwidth B results in higher resolution in the distance estimation, but it also decreases the maximum unambiguous delay unless fₛ/B>1.

Dependence on linear frequency modulation: Conventional processing for FMCW ranging relies on accurate linear FM for distance estimation. However, precise frequency control is a challenging task; some proposed solutions add complexity to the hardware, and proposed software solutions add computation cost while still being held back by sample inefficiency and limited range.

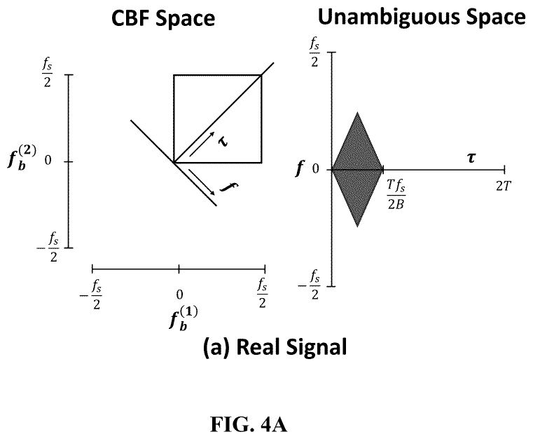

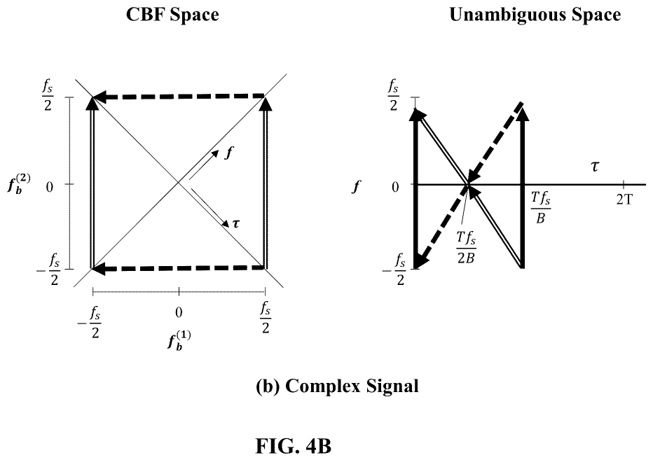

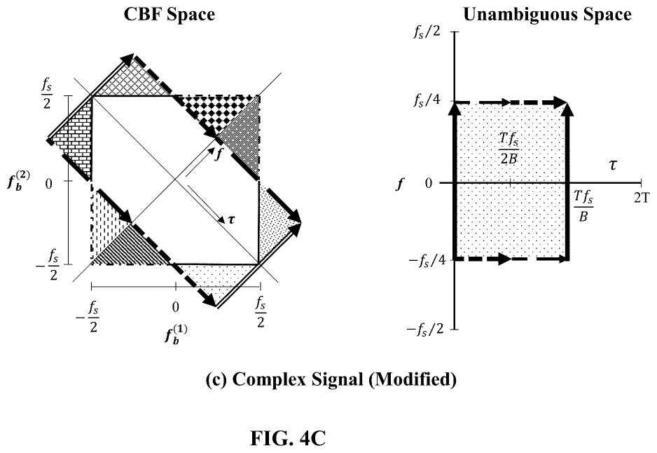

Some embodiments are directed towards recovery of the (τ, f) from the full received signal. First consider the estimation of τ and f from two CBFs. For three cases, FIGS. 4A-4C illustrate the observations (CBF space) and a corresponding unambiguous (delay, Doppler) space. Particularly, FIG. 4A shows the CBF space and unambiguous space for a real signal; FIG. 4B shows the CBF space and unambiguous space for a complex signal; and FIG. 4C shows the CBF space and unambiguous space for a modified complex signal where an alternate mapping is utilized.

CBF space refers to the possible values for the beat frequency pair

$$( {f}_{b}^{( 1 )} , {f}_{b}^{( 2 )} ) .$$

Interpretations are based on τ being non-negative and a symmetric interval for f being desirable. Referring to FIG. 4A, a real observation gives only

$$( \vert {f}_{b}^{( 1 )} \vert , \vert {f}_{b}^{( 2 )} \vert ) ,$$

which limits the unambiguous (τ, f) relative to having a complex observation. Referring to FIG. 4B, a straightforward interpretation of a complex observation results in an undesirable (τ, f) space with no Doppler resolution at worst-case delay. Referring to FIG. 4C, an alternative mapping creates a rectangular (τ, f) space.

It shall be noted that the sum and difference of CBFs in Equation (14) is why τ and f directions are marked as they are in the CBF-space plots of FIG. 4A-4C. The threshold for aliasing is τ=Tfₛ/(2B) and it reaches the lower-right corner of the CBF space shown in FIGS. 4A-4C. From Equation 14, the CBF pairs with

$${f}_{b}^{( 1 )} - {f}_{b}^{( 2 )} < 0$$

would give negative delay, which is physically impossible. By wrapping to compensate for aliasing, the interval of recoverable τ values may be extended to (0, T fₛ/B). With this care in interpretation, the square CBF space maps to the butterfly-shaped (τ, f) space shown in FIG. 4A.

Having only real (in-phase component) observations restricts the CBFs to their absolute values (shown in bottom row of FIG. 3B as positive and negative frequencies appearing together). Relative to FIG. 4B, the CBF space is reduced to one quadrant, as shown in FIG. 4A. Denote the observations by

$${f}_{real}^{( i )} = \vert {f}_{b}^{( i )} \vert , i = 1 , 2. Also , {f}_{real}^{( 2 )} = - {f}_{b}^{( 2 )} ,$$

so

$$τ = \frac{1}{2} ( T / B ) ( {f}_{real}^{( 1 )} + {f}_{real}^{( 2 )} ) , f = \frac{1}{2} ( {f}_{real}^{( 1 )} - {f}_{real}^{( 2 )} ) \qquad ( 17 )$$

These directions are marked in the CBF-space plot in FIG. 4A. The unambiguous (τ, f) space is a rhombus.

Returning to the complex case, aliasing as a modulo operation is marked in FIG. 4B with solid dashed and doubly compounded arrows to indicate that the CBF space is a 2-torus. Some embodiments propose changing the interpretation of some observed CBFs to make the unambiguous space rectangular, as shown in FIG. 4C with shaded triangular pairs. Even in this modified version, the delay and Doppler that can be recovered must be within

$$( τ , f ) ∈ ( 0 , \frac{{Tf}_{s}}{B} ) \times ( - \frac{1}{4} {f}_{S} , \frac{1}{4} {f}_{S} ) .$$

There is a trade-off between maximum delay and sensitivity to the delay; one might have to compromise the resolution of the distance in order to be able to detect longer range. As noted earlier, using multiple chirps would lower the frame rate.

Some embodiments are directed towards resolving a larger (τ, f) space. Denote the instantaneous frequency of u(t), neglecting noise, by g_{τ,f}(t), where eq. 12 gives the example of triangular modulation. Because of the periodicity of the frequency modulation and aliasing caused by the sampling rate, g_{τ,f}(t) is periodic with respect to all arguments:

g_{τ,f}(t)=g_{τ,f}(t+2T),

g_{τ,f}(t)=g_{τ+2T,f}(t),

g_{τ,f}(t)=g_{τ,f}+fₛ(t). (18)

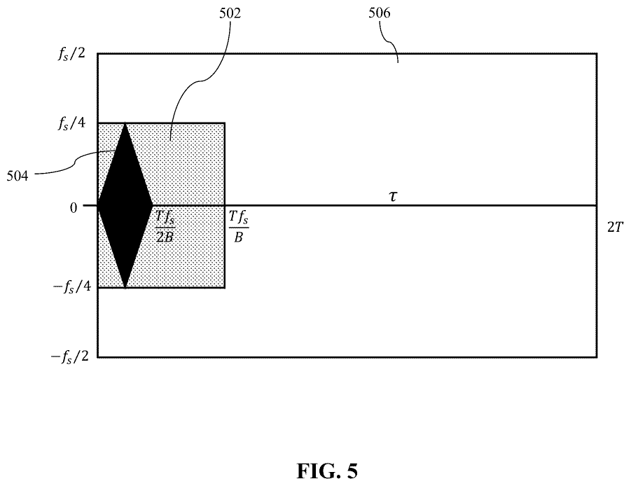

As long as g_{τ,f}(t) is unique for all (τ, f)∈(0,2T)×(−fₛ/2, fₛ/2), that much larger set is the unambiguous (τ, f) space, as shown in FIG. 5 which illustrates a comparison of unambiguous range of (τ, f) space of conventional vs the proposed processing of FMCW signal. The space 502 shows the complex space of conventional processing systems while the space 504 shows the real space of the conventional processing systems. It may be observed that having large chirp rate, B/T increases accuracy of the estimates. However, where bandwidth is too large (B>fₛ/2), the distance and velocity that can be solved for by the conventional processing is limited. The proposed approach in accordance with several example embodiments can solve for a range that is independent of the bandwidth. The unambiguous range of (τ, f) space solvable for by the proposed approach is shown as the space 506. Some embodiments are directed towards recovering (τ, f) from data that provides at best a noisy version of g_{τ,f}(t), benefiting from possible parametric forms for g.

It is a realization of some embodiments that maximum periodogram does not model the correlated phase noise in FMCW signal. Although Lorentzian fitting does consider phase noise but periodogram is not suitable for signal with frequency changing with time. Considering that only a single echo exists in the observed interference signal, the instantaneous frequency can be estimated from the sampled signal as:

$$ζ [ n ] = \frac{1}{2 π} arg \{ u [ n + 1 ] \overline{u} [ n ] \} \qquad ( 19 )$$

If sample length of u[n] is N then sample length of ζ[n] is N−1. This estimate is independent of the global constant phase offset. The FMCW system disclosed in accordance with some embodiments, solves for delay τ and Doppler shift f by minimizing the distance between instantaneous frequency estimate ζ[n] and noiseless instantaneous frequency in discrete time g_{τ,f}(t):

$${min}_{τ , f} ℒ ( ζ , {g}_{τ , f} ( t ) ) \qquad ( 20 )$$

Both g_{τ,f}(t) and ζ[n] range from −0.5 to 0.5. Some embodiments use a negative log-likelihood as [symbol] . However, finding the closed form for the likelihood function may be challenging. Accordingly, some embodiments use a finite sum approximation of wrapped normal distribution as the likelihood.

$$ℒ = {\sum }_{n = 1}^{N - 1} - log ( {\sum }_{k = - K}^{K} exp ( - \frac{{( ζ [ n ] - {g}_{τ , f} [ n ] - k )}^{2}}{2 {σ}^{2}} ) ) a . \qquad ( 21 )$$

Primarily, there are two sources of noise that are considerable in u[n]: shot noise ηᵤ[n] and phase noise ξ[n]. The phase noise ξ[n] is a correlated Gaussian process while the shot noise ηᵤ[n] is a Skellam random process (difference of Poisson). Some embodiments model the signal as:

u[n]=Ae^{j(φ[n]+ξ[n])}+ηᵤ[n]=Ãe^{j(φ[n]+ξ[n]+λ[n])}

The obtained Ã is a Rician random variable and λ[n] is ηᵤ[n] projected to phase space. As such the obtained instantaneous frequency ζ may be written as a sum of deterministic term g_{τ,f}(t) and the noise terms δ (from phase noise) and ϵ (from shot noise):

ζ[n]=g_{τ,f}[n]+δ[n]+ϵ[n] (22)

where δ[n] is a transformed phase noise and ϵ[n] is a transformed shot-noise.

δ[n] [symbol] Ω_{2π}((ξ[n+1]−ξ[n]))/(2π) (23)

ϵ[n] [symbol] Ω_{2π}((λ[n+1]−λ[n]))/(2π) (24)

Because ξ follows a multivariate Gaussian distribution, δ follows a multivariate wrapped normal distribution.

$${p}_{δ} ( z ) = {\sum }_{{k}_{1} = - ∞}^{+ ∞} … {\sum }_{{k}_{N} = - ∞}^{+ ∞} \frac{exp ( \frac{1}{2} κ ( z - k ) )}{\sqrt{{( 2 π )}^{N} \vert {\sum }_{δ}^{u n w r a p} \vert}} \qquad ( 25 )$$

$$κ ( z - k ) = {( z - k )}^{T} {( {\sum }_{δ}^{unwrap} )}^{- 1} ( z - k ) \\ {\sum }_{δ}^{unwrap} = \frac{1}{{( 2 π )}^{2}} D {\sum }_{ξ} {D}^{T}$$

Σ_{ξ} is a covariance matrix of ξ and D is a N−1×N difference matrix. As a result, a sparse covariance matrix

$${\sum }_{δ}^{unwrap}$$

is obtained.

$${[ {\sum }_{δ}^{unwrap} ]}_{i , j} = \{ \begin{matrix}\frac{1}{π} L {Δ}_{t} & i = j \\ \frac{1}{2 π} L ( τ - ( ⌊ \frac{τ}{{Δ}_{t}} ⌋ + 1 ) {Δ}_{t} ) & \vert i - j \vert = ⌊ \frac{τ}{{Δ}_{t}} ⌋ \\ \frac{1}{2 π} L ( ⌊ \frac{τ}{{Δ}_{t}} ⌋ {Δ}_{t} - τ ) & \vert i - j \vert = ⌊ \frac{τ}{{Δ}_{t}} ⌋ + 1 \\ 0 & else\end{matrix} \qquad ( 26 )$$

It may be noted that the distribution function of ϵ[n] is not available in a simple form. In high SNR, ϵ[n] has low variance and dominated by the phase noise δ. Some embodiments are directed towards modelling a region where phase noise dominates. Accordingly, the wrapped normal distribution is used to characterize for sum of both noise terms. However, computing the infinite sum and accounting for correlation in multivariate normal distribution is computationally intractable. Therefore, independent wrapped normal distribution with finite sum is chosen as an approximate likelihood function.

In the absence of λ,

$${σ}^{2} = \frac{1}{π} L {Δ}_{t} .$$

Presence of λ should broaden the mode of the distribution. Since λ is a noise term that is projected to phase space, σ² is modelled in the presence of both noise terms as

$${σ}^{2} = \frac{1}{π} L {Δ}_{t} + h ( {SNR}_{η} ) \qquad ( 27 )$$

SNR_{η} is a function of many unknown parameters such as distance, reflectance, incident angle, and atmospheric absorption. Some embodiments estimate the value of SNR_{η} using auxiliary signal v which is defined as:

$$v ( t ) = [ {y}_{+}^{I} ( t ) + {y}_{-}^{I} ( t ) ] + j [ {y}_{+}^{Q} ( t ) + {y}_{-}^{Q} ( t ) ] \qquad ( 28 )$$

$$S \hat{N} {R}_{η} = \frac{{‖ u ‖}_{2}^{2} - \frac{q}{N} {\sum }_{n} v [ n ]}{\frac{q}{N} {\sum }_{n} v [ n ]} \qquad ( 29 )$$

For the function h(⋅), Fréchet variance is regressed over SNR_{η}. To compute the Fréchet variance, η is simulated for different SNR_{η} values that are then projected to λ. Once the function estimate ĥ is obtained,

$${\hat{σ}}^{2} = \frac{1}{π} L {Δ}_{t} + \hat{h} ( S \hat{N} {R}_{η} ) \qquad ( 30 )$$

g_{τ,f} is a collection of aliased frequencies g_{τ,f}[n]∈[−0.5, 0.5), and each space behave similarly to a circle. Hence, it is natural to think of the space for g_{τ,f} as hypertorus, a high dimensional extension of torus. Since g_{τ,f} is parameterized by 2-dimensional parameters, it may be observed that g_{τ,f} should exist in a 2 dimensional subspace [symbol] in the N−1 dimensional hypertorus [symbol] . The subspace [symbol] along with the entire space T is a quotient manifold, meaning, just like a circle, moving along one direction will eventually lead back to the starting point. This makes sense, after all, g_{τ,f} is periodic, as mentioned previously.

This leads to solvable space of (τ, f), which significantly larger than

$$d ∈ ( 0 , {cT}_{chirp} ] , v ∈ ( - \frac{{f}_{s} {λ}_{c}}{4} , \frac{{f}_{s} {λ}_{c}}{4} ) \qquad ( 31 )$$

This subspace is obtained by measuring the (geodesic) distance between two different points on [symbol] . Using Euclidean metric, minimum geodesic distance between g_{τ}_{₁}_{,f}_{₁} and g_{τ}_{₂}_{,f}_{₂} is calculated by

$${𝒟}^{2} ( {g}_{{τ}_{1} , {f}_{1}} , {g}_{{τ}_{2} , {f}_{2}} ) = {\sum }_{n = 0}^{N - 2} {{Ω}_{1} ( {g}_{{τ}_{1} , {f}_{1}} [ n ] - {g}_{{τ}_{2} , {f}_{2}} [ n ] )}^{2} \qquad ( 32 )$$

In fact, minimizing this geodesic distance between ζ and g_{τ,f} is equivalent to minimizing the negative log-likelihood of the wrapped normal distribution with σ²→0.

Some embodiments are directed towards running multiple gradient descents from different initial points. In order to reduce the complexity of processing, some embodiments aim to minimize the number of runs of gradient descents. Since the landscape of the objective and approximately where the local maxima occur are known, the grid of initial points for gradient descent may be constructed efficiently.

The required resolution of the grid of initial points is influenced by the size of the rhombus that contains the global minima. For triangular modulation, the rhombus with global minima has the diagonals of

$${Δ}_{τ} = \frac{{f}_{s} T}{B} , {Δ}_{f} = f$$

and for sinusoidal modulation, the rhombus with global minima has the diagonals of

$${Δ}_{τ} \approx arcsin ( \frac{{f}_{s}}{2 B} ) \frac{2 T}{π} , {Δ}_{f} = f .$$

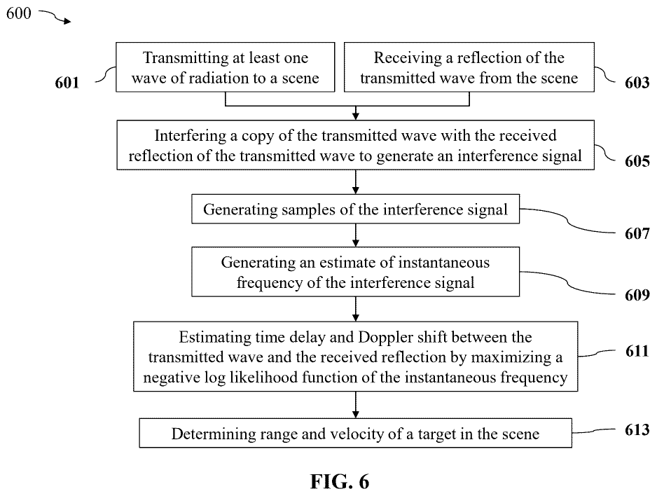

FIG. 6 illustrates a method for estimating range and velocity of a target in a scene, according to some example embodiments. The method 600 may be compiled and executed as a control process for the FMCW lidar system. In some example embodiments, the method 3600 may comprise actions performed by one or more components of the FMCW lidar system 200. The method 600 comprises transmitting 601 at least one wave of radiation to a scene. The transmission 601 may be preceded by preprocessing such as generating and steering the at least one wave of radiation which may be performed by any suitable irradiation source such as a laser, a UV lamp, an IR lamp. Also, the preprocessing may comprise obtaining a local copy of the transmitted wave. The transmission 601 may comprise utilizing suitable optics and associated electronics to direct the at least one wave of radiation towards the scene.

The scene may contain one or more objects and upon irradiation, the one or more objects may transmit back a reflection of the transmitted wave of radiation. The reflection of the transmitted wave may be received 603 from the scene by one or more receivers. The method 600 further comprises interfering 605 the copy of the transmitted wave with the received reflection of the transmitted wave to generate an interference signal. The interference may be performed in the manner described previously with respect to FIG. 1A and FIG. 2A. The interference signal is generated 607 as a sequence of samples. The method also comprises generating 609 an estimate of the instantaneous frequency of the interference signal. The estimated instantaneous frequency is a noisy estimate of the instantaneous frequency. Thereafter, the time delay and Doppler shift between the transmitted wave and the reflected wave are estimated 611 by maximizing a distance between the noisy estimate of the instantaneous frequency and a noiseless estimate of the instantaneous frequency in discrete time. The method terminates with determination 613 of the range and velocity of the target object in the scene.

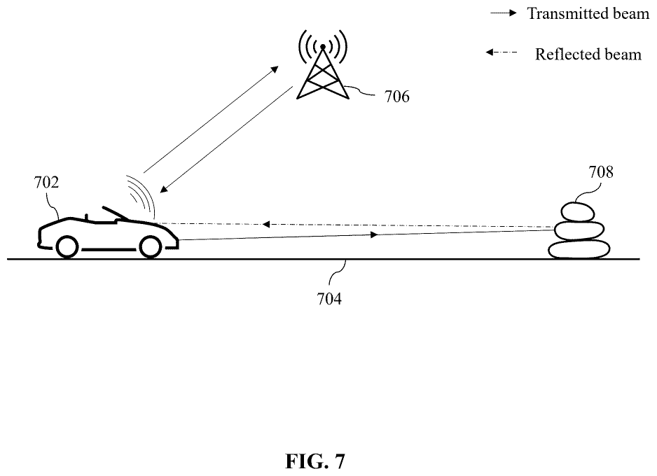

FIG. 7 illustrates a scenario depicting an example use case of an FMCW lidar system, according to some example embodiments. A vehicle 702 moving on a road link 704 may be connected to a base station 706. The road link may have one or more obstacles 708 and the goal may be to traverse the road link 704 without colliding with the obstacles 708. Towards this end, it is required that a correct estimation of the depth/range and/or the relative approach velocity of the obstacles 708 be determined so that a route for the vehicle 702 may be planned to avoid collision with the obstacles 708.

The vehicle 702 may be a manually driven vehicle, a semi-autonomous vehicle or a fully autonomous self-driving vehicle and may be configured for communication with the base station 706. In this regard, the vehicle 702 may be equipped with suitable components to execute remote sensing, data communication, and data processing. Towards this end, it may be contemplated that the vehicle may be equipped with an onboard FMCW lidar system such as the ones described earlier. An emitter of the lidar system transmits a wave or beam of radiation (shown as solid line) towards the obstacles 708 and receives a reflection (shown as dotted line) of the transmitted wave/beam from the scene ahead. Since the obstacles 708 may be beyond the unambiguous range of the lidar or the vehicle 702 may be moving and/or due to errors in the source laser, the depth estimation of the obstacles 708 may not be correctly inferable using conventional techniques.

The vehicle 702 may invoke the FMCW lidar system to perform accurate depth estimation for the obstacles 708. The FMCW lidar system may fully or partially be onboard the vehicle 702. In embodiments where the FMCW lidar system is partially onboard the vehicle 702, the computation steps leading to frequency estimation may be performed via edge computing on the base station 706. In some example embodiments, the vehicle 702 may determine through the FMCW lidar system, the correct range of the obstacles 708 in accordance with the framework and methodology described previously in the disclosure. Thereby the geo-location of the obstacles 708 may be determined from the estimated range. Accordingly, the onboard controller of the vehicle 702 may reroute the vehicle 702 to avoid collision with the obstacles 708. In some example embodiments, the vehicle 702 may additionally or alternately convey at least the geo-location of the obstacles 708 to the base station 706 for updating a map of the area in which the road link 704 exists.

Although the example use case is described with reference to an on-road vehicle, example embodiments described herein may be applicable to any type of vehicle such as an aerial vehicle, an aquatic vehicle, a spacecraft, and the like. Other example uses of some embodiments include industrial robotics, computer vision systems and autonomous driving.

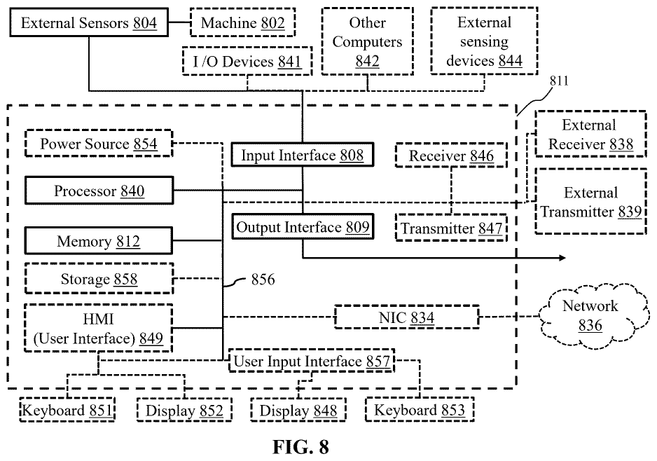

FIG. 8 illustrates a block diagram of a system for implementing an FMCW lidar system, according to some example embodiments. A controller may include a processor 840, a computer readable memory 812, storage 858 and user interface 849 with optional display 852 and keyboard 851, which are connected through bus 856. For example, the user interface 864 in communication with the processor 840 and the computer readable memory 812, acquires and stores the image data in the computer readable memory 812 upon receiving an input from a surface, keyboard 853 of the user interface 857 by a user.

The computer 811 can include a power source 854, depending upon the application the power source 854 may be optionally located outside of the computer 811. Linked through bus 856 can be a user input interface 857 adapted to connect to a display device 848, wherein the display device 848 can include a computer monitor, camera, television, projector, or mobile device, among others. A network interface controller (NIC) 834 is adapted to connect through the bus 856 to a network 836, wherein image data or other data, among other things, can be rendered on a third-party display device, third party imaging device, and/or third-party printing device outside of the computer 811.

Still referring to FIG. 8, the image data or other electronic data, among other things, may be transmitted over a communication channel of the network 836, and/or stored within the storage system 858 for storage and/or further processing. Further, the time series data or other data may be received wirelessly or hard wired from a receiver 846 (or external receiver 838) or transmitted via a transmitter 847 (or external transmitter 839) wirelessly or hard wired, the receiver 846 and transmitter 847 are both connected through the bus 856. The computer 811 may be connected via an input interface 808 to external sensing devices 844 and external input/output devices 841. For example, the external sensing devices 804 may include sensors gathering data before-during-after of the collected time-series data of the machine. The computer 811 may be connected to other external computers 842. An output interface 809 may be used to output the processed data from the processor 840. It is noted that a user interface 849 in communication with the processor 840 and the non-transitory computer readable storage medium 812, acquires and stores the region data in the non-transitory computer readable storage medium 812 upon receiving an input from a surface of the user interface 849 by a user.

In this way, various example embodiments described herein provide techniques for joint estimation of distance and velocity of movable targets by regressing on the instantaneous frequency of the interference signal. Various embodiments consider the entire measurement sequence to enable unambiguous recovery of range beyond the limit set by the Nyquist rate despite the ambiguity introduced by aliasing. As an extended effect, various embodiments also prove that the linear frequency modulations are not ideal and that range and velocity can be simultaneously estimated with aliased and non-linear FMCW lidar. The distance that can be solved for is limited by neither the bandwidth nor the sampling rate.

The above description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements. Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks. Various methods or processes outlined herein may be coded as software that is executable on one or more processors that employ any one of a variety of operating systems or platforms. Additionally, such software may be written using any of a number of suitable programming languages and/or programming or scripting tools and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Further, use of ordinal terms such as “first,” “second,” in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish the claim elements. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A frequency modulation continuous wave (FMCW) device, comprising:
an emitter configured to transmit at least one wave of radiation to a scene, wherein the transmitted wave is modulated in frequency domain;
a receiver configured to receive a reflection of the transmitted wave from the scene;
a mixer operatively connected to the emitter and the receiver and configured to interfere a copy of the transmitted wave with the received reflection of the transmitted wave to generate an interference signal;
an analog-to-digital converter (ADC) operatively connected to the mixer and configured to generate samples of the interference signal; and
a processor configured to:
generate an estimate of instantaneous frequency of the interference signal, based on the samples of the interference signal;
estimate time delay and Doppler shift between the transmitted wave and the received reflection by maximizing a negative log likelihood function of the instantaneous frequency; and
determine range and velocity of a target in the scene based on the estimated time delay and Doppler shift between the transmitted wave and the received reflection.

2. The FMCW device of claim 1, wherein the transmitted wave is modulated in the frequency domain using a modulation function that is subject to one or more impairments.

3. The FMCW device of claim 1, wherein the instantaneous frequency of the interference signal is periodic with respect to all arguments.

4. The FMCW device of claim 1, wherein the estimated instantaneous frequency of the interference signal is independent of a phase offset for the instantaneous frequency.

5. The FMCW device of claim 1, wherein the estimated instantaneous frequency is a noisy estimate of the instantaneous frequency, and wherein to estimate the time delay and Doppler shift between the transmitted wave and the received reflection, the processor is configured to minimize a distance between the noisy estimate of the instantaneous frequency and a noiseless estimate of the instantaneous frequency in discrete time.

6. The FMCW device of claim 5, wherein the instantaneous frequency of the interference signal is modeled as a sum of the noiseless estimate of the instantaneous frequency in discrete time, a phase noise term and a shot noise term, wherein the phase noise term defines phase noise in the interference signal and the shot noise term defines shot noise associated with a detector of the receiver.

7. The FMCW device of claim 6, wherein the phase noise term follows a multivariate wrapped normal distribution.

8. The FMCW device of claim 1, wherein the negative log likelihood function is a finite sum approximation of wrapped normal distribution of phase noise associated with the interference signal.

9. A Lidar including the FMCW device of claim 1.

10. A Lidar including the FMCW device of claim 1, wherein the emitter includes a laser source with a coherence length shorter than the distance to the target.

11. A frequency modulation continuous wave (FMCW) based range estimation method, comprising:
transmitting at least one wave of radiation to a scene, wherein the transmitted wave is modulated in frequency domain;
receiving a reflection of the transmitted wave from the scene;
interfering a copy of the transmitted wave with the received reflection of the transmitted wave to generate an interference signal;
generating digital samples of the interference signal;
generating an estimate of instantaneous frequency of the interference signal, based on the samples of the interference signal;
estimating time delay and Doppler shift between the transmitted wave and the received reflection by maximizing a negative log likelihood function of the instantaneous frequency; and
determining range and velocity of a target in the scene based on the estimated time delay and Doppler shift between the transmitted wave and the received reflection.

12. The method of claim 11, wherein the transmitted wave is modulated in the frequency domain using a modulation function that is subject to one or more impairments.

13. The method of claim 11, wherein the instantaneous frequency of the interference signal is periodic with respect to all arguments.

14. The method of claim 11, wherein the estimated instantaneous frequency of the interference signal is independent of a phase offset for the instantaneous frequency.

15. The method of claim 11, wherein the estimated instantaneous frequency is a noisy estimate of the instantaneous frequency, and wherein to estimate the time delay and Doppler shift between the transmitted wave and the received reflection, the processor is configured to minimize a distance between the noisy estimate of the instantaneous frequency and a noiseless estimate of the instantaneous frequency in discrete time.

16. The method of claim 15, wherein the instantaneous frequency of the interference signal is modeled as a sum of the noiseless estimate of the instantaneous frequency in discrete time, a phase noise term and a shot noise term, wherein the phase noise term defines phase noise in the interference signal and the shot noise term defines shot noise in the interference signal.

17. The method of claim 16, wherein the phase noise term follows a multivariate wrapped normal distribution.

18. The method of claim 11, wherein the negative log likelihood function is a finite sum approximation of wrapped normal distribution of phase noise associated with the interference signal.
